(19) United States
(12) Patent Application Publication
(10) Pub. No.: US 2011/0059199 A1
(43) Pub. Date: Mar. 10, 2011

(54) MOLD FOR BLOCKS WIH MOVABLE CAVITY WALLS

(76) Inventor: Horacio CORREIA, Terrebonne (CA)

(21) Appl. No.: 12/876,620

(22) Filed: Sep. 7, 2010

Related U.S. Application Data
(60) Provisional application No. 61/272,270, filed on Sep. 4, 2009.

(51) Int. Cl. B29C 43/36; B29C 33/00; B29C 33/44; B29C 43/02

(52) U.S. Cl. 425/358; 425/470; 425/457

(57) ABSTRACT

A mold for cementitious blocks comprises a main body having at least one pair of spaced apart lateral walls with at least one pair of spaced apart divider walls extending therebetween. The lateral walls and divider walls define a cavity therebetween for receiving cementious material to be compacted into a block. The cavity includes open top and bottom faces. At least one of the spaced apart lateral walls is movable inwardly into the cavity. A vertically movable actuator element acts on this movable lateral wall. This actuator extends outwardly of the main body such that when it is moved inwardly it so acts on the movable wall as to move it inwardly into the cavity thereby providing a cementitious block with a sloped lateral side.

### CROSS-REFERENCE TO RELATED APPLICATIONS

The present application claims priority on U.S. Provisional Patent Application Ser. No. 61/272,270 filed on Sep. 4, 2009 and incorporated herein in its entirety.

### TECHNICAL FIELD

The present description relates to blocks such as cementitious blocks including pavers having sloped sides. More specifically but not exclusively, the present description n relates to a mold for blocks with movable cavity walls.

### BACKGROUND

There is known in the art of variety of molds for providing blocks which have sloped sides. Such blocks are usually made of cementitious materials and used as pavers or as wall retainers and alike and they have a generally rectangular shaped configuration with a larger generally flat face opposite a smaller generally flat face with the walls there between being generally sloped. The front and back ends are usually flat and straight.

A drawback of many of the blocks provided through conventional molds is that it is very difficult to provide an imprint on the larger face.

A drawback with the molds for providing blocks with sloped sides is that they use a variety of hydraulic or pneumatic systems that are expensive to install and to maintain and very easy to damage and costly to repair.

There remains a need for improved systems to provide molds with sloped sidewalls.

### OBJECTS

It is an object of the present description to provide a mold for blocks having movable cavity walls.

### SUMMARY

In accordance with an aspect of the present disclosure, there is provided a mold for molding material into blocks comprising:

a main body comprising at least one pair of spaced apart lateral walls with at least one pair of spaced apart divider walls extending therebetween so as to define at least one cavity for receiving material therein, at least one of the walls being movable inwardly into the cavity; and

a movable actuator element for acting on the movable wall, the movable actuator element extending outwardly of the main body such that when moved inwardly it so acts on the movable wall as to move it inwardly into the cavity.

In an embodiment, the movable actuator element is positioned adjacently the movable wall. In an embodiment, the movable actuator element is outwardly biased. In an embodiment, the movable actuator element is connected to a spring for being outwardly biased thereby. In an embodiment, the movable actuator element comprises a push member that pushes the movable wall inwardly into the cavity as the movable actuator element is moved inwardly. In an embodiment, the push member along the length of the movable actuator element is adjustable so as to vary the degree that the movable wall is pushed into the cavity. In an embodiment, the outward position of the movable actuator element relative to the main body is selectively adjustable so as to provide for moving the movable wall to a corresponding position into the cavity. In an embodiment, the movable actuator element is adjustable between at least first and second positions, the movable actuator element extending outwardly of the main body to a greater degree in the second position than in the first second position, wherein when the movable actuator element is moved inwardly from the second position it moves the movable wall inwardly into the cavity to a greater degree than when moved inwardly from the first position.

In an embodiment, the main body comprises a top face and a bottom face, the movable actuator element extending outwardly from the bottom face, such that when moved upwardly it causes the movable wall to move inwardly into the cavity.

In an embodiment, the movable wall is pivotally mounted to the main body. In an embodiment, the movable wall comprises a movable portion thereof pivotally mounted to another immovable portion thereof. In an embodiment, the cavity comprises an open top face to receive a press so as to compact the material, the immovable wall portion comprising a recessed end adjacent the cavity top. In an embodiment, the movable and immovable wall portions are offset relative to one another so as to provide a recess therebetween. In an embodiment, the movable wall comprises a rear side comprising a lever that is pushed by the movable actuator element when moved inwardly in the main body.

In an embodiment, the mold further comprises at least two side by side the cavities separated by a wall section, the wall section comprising the movable wall and an adjacent second movable wall, the movable actuator element being interposed between the two adjacent movable walls, wherein when the movable actuator element is moved inwardly it so acts on the adjacent movable walls as to move each one into a respective the side by side cavity.

In accordance with an aspect of the present disclosure, there is provided a mold comprising:

a plurality of spaced apart wall sections;

a plurality of lateral walls extending between each pair of adjacent wall sections thereby defining adjacent rows of cavities, each cavity providing for receiving material therein to be compacted, each wall section comprising adjacent movable walls for being moved into a respective one of two adjacent cavities; and

a plurality of movable actuation elements, each element interposed between a pair of adjacent movable walls and extending outwardly of the main body such that when moved inwardly it so acts on the adjacent movable walls as to move each one inwardly into a respective one of two the adjacent cavities.

In accordance with an aspect of the present invention, there is provided a mold for blocks comprising:

a main body comprising at least one pair of spaced apart lateral walls with at least one pair spaced apart divider walls extending therebetween so as to define at least one cavity having open top and bottom faces for receiving material therein, at least one of the walls being movable inwardly into the cavity; and

a vertically movable actuator element for acting on the movable wall, the actuator extending downwardly such that when it is moved upwardly it so acts on the movable wall as to move it inwardly into cavity.

Other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective view of the mold in accordance with a non-restrictive illustrative embodiment of the present description;

FIG. 2 is top plan view of the mold of FIG. 1;

FIGS. 3A, 3B and 3C are side sectional views of the mold of FIG. 1 taken along the width thereof;

FIG. 4 are a side sectional view of the mold of FIG. 1 taken along the length thereof; and

FIG. 5 is front elevation view of a cementitious block.

### DETAILED DESCRIPTION OF ILLUSTRATIVE EMBODIMENTS

Generally stated, in embodiment there is provided a mold for blocks comprising a body that includes at least one cavity with open top and bottom faces for receiving material therein to form a block. The cavity is formed between a pair of spaced apart lateral walls and a pair of spaced apart divider walls extending between the pair of spaced apart walls. At least one of these walls is movable into the cavity so as to provide a block with at least one sloped side. This lateral wall is movable by a mechanical actuator element that extends outwardly from the main body such that when it is moved inwardly it so acts on this movable wall as to move it inwardly into the cavity.

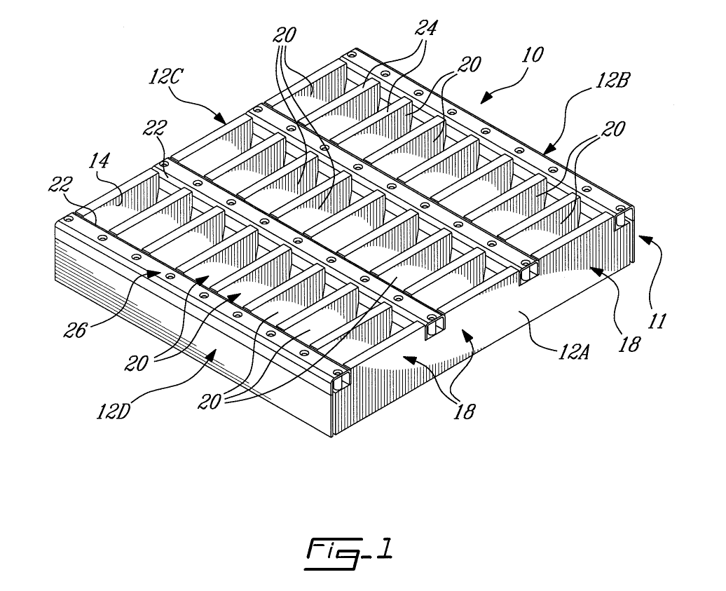

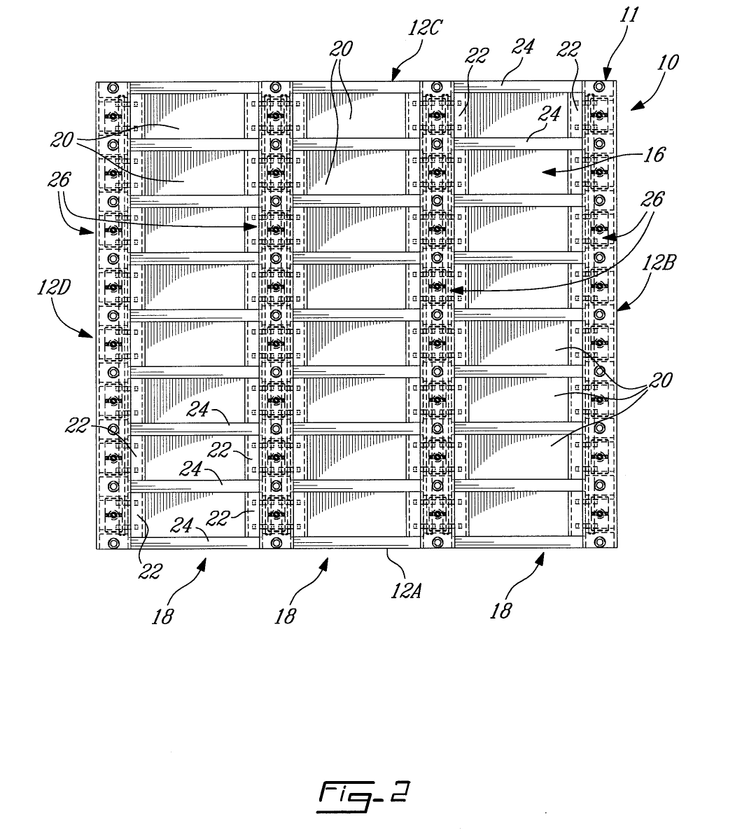

FIGS. 1 and 2 show a mold 10 in accordance with a non-restrictive illustrative embodiment.

The mold 10 includes a generally rectangular body 11 having four lateral sides 12A, 12B, 12C and 12D, and including an open top and bottom faces 14 and 16, respectively. The mold 10 includes three rows 18 of cavities 20.

Each cavity 20 provides for molding material therein into a block structure 21 (see FIG. 5) when compacted.

With respect to FIGS. 1, 2 and 3A-3C, the cavities 20 are formed between spaced apart adjacent lateral walls 22 and spaced apart divider walls 24 extending between adjacent lateral walls 22.

Turning to FIG. 5, the divider walls 24 define the front and rear faces 23 of the blocks 21, the lateral sloped sides 25 are provided by the lateral walls 22. The top and bottom faces, 27 and 29 of the molded block 21 are respectively defined between the top and bottom open faces 14 and 16. The Top face 14 is engaged by a press P while the bottom face sits on a pallet (not shown) (not shown) thereby molding material into a block structure 21.

The Figures show that the mold 10 includes longitudinal actuator assembly 26 mounted at each lateral side of the divider walls 24 for actuating the side walls 22. The longitudinal actuator assemblies 26 are fixedly mounted between adjacent rows 18 and at the lateral sides 12B and 12D.

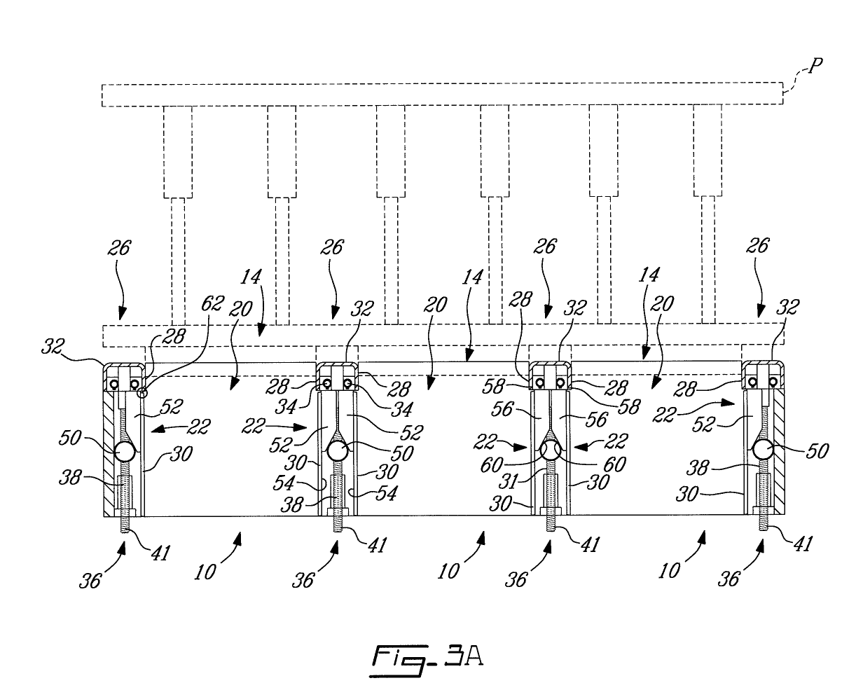

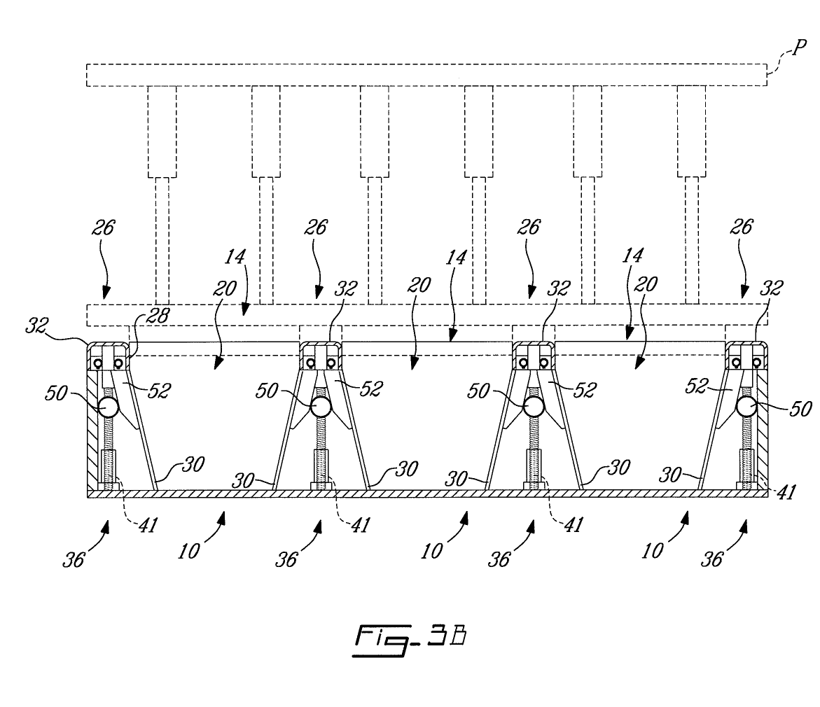

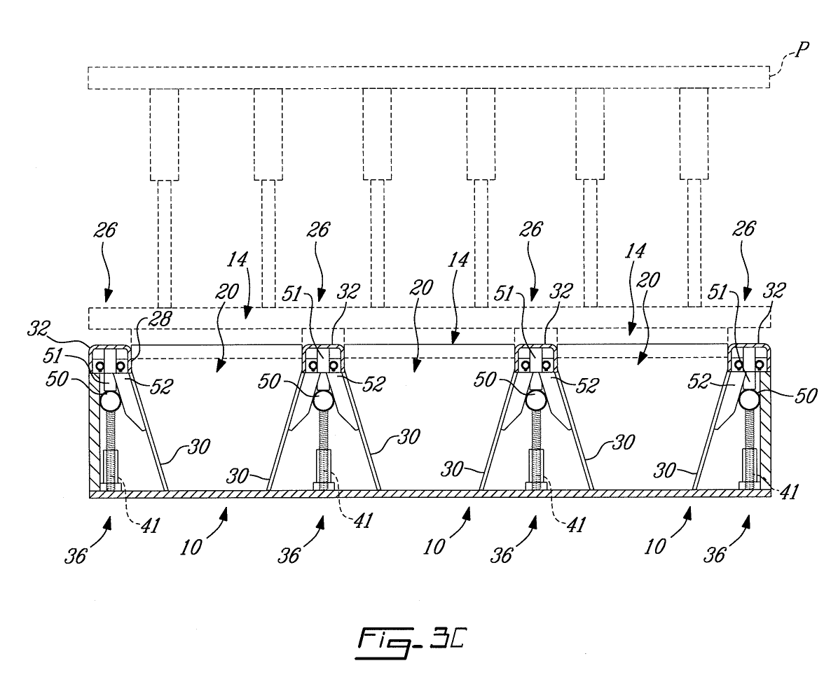

With respect to FIGS. 3A-3C, the lateral walls 22 include top immovable portions 28 which are recessed relative to bottom longer movable walls portions 30.

A row of lateral longitudinal actuator assemblies 26 and lateral walls 22 define wall sections, each adjacent pair of wall sections includes plurality of divider walls 24 extending therebetween.

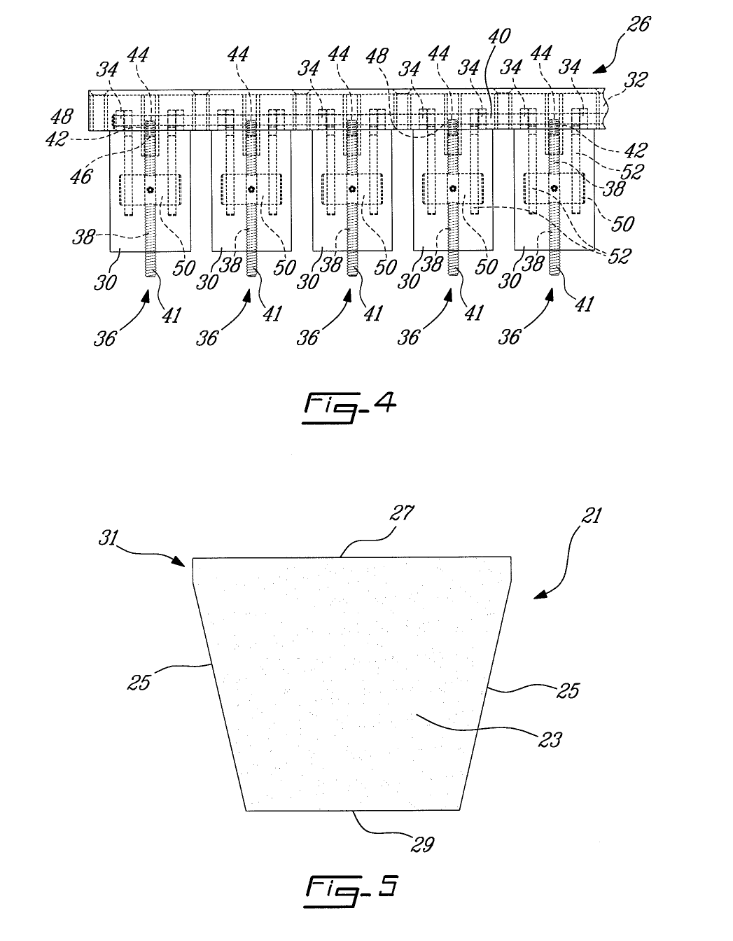

Turning to FIGS. 3A-3C and 4, the actuator assemblies 26 include respective longitudinal brackets 32 mounted between the top portions 28 of the lateral walls 22. The movable wall portions 30 of two adjacent side walls 22, are pivotally mounted to the bracket 32 via pivot members 34. A plurality of mechanical actuator devices 36 extend from each bracket 32. Each device 36 is positioned between a pair of movable wall portions 30 of two adjacent cavities 20.

The mechanical actuator assembly 36 includes an actuator element in the form of pin member 38, which can include a threaded body, being movably mounted to a longitudinal rod 40 within the bracket 32 and including an opposite free end portion 41. The pin member 38 also includes a top shaft element 42 carrying a spring member 44. The spring 44 is sandwiched between shoulders 46 and 48 formed by the pin member 30 and rod 40 respectively. As such, the pin member 38 is biased downwardly so as to protrude outwardly from the bottom open face as shown in FIG. 7. The pin member 38 carries a cylindrical push member 50 for acting on the adjacent movable wall portions 30. A tubular guide 39 is provided for guiding the pin 38 as it moves relative to the

In this respect, the movable wall portions 30 include respective levers 52 on their rear sides 54. The levers 54 have longitudinal body 56 with the top end 58 that is pivotally mounted to the rod 40 and lower recessed end 60.

When the pin member 38 is in the downward position between two movable wall portions 30, the cylindrical push member 50 is positioned between the recessed ends 60 of adjacent levers 54 which provide an inverted v-space therebetween. When the pin bottom free end portion 41 protruding through the tubular guide 39 from the bottom open face 16 of the mold 10 engages a surface the pin member 38 is moved upwards. The foregoing causes the cylindrical push member 50 to move upwardly between the levers 54 thereby pushing the levers 54 away from each other. FIG. 3C shows that the cylindrical push member 50 engages a sleeve stopper 51 which defines the maximum upward movement of the pin member 38. This of course, moves the wall portions 30 into the cavity 20 thereby defining sloped lateral walls 22.

When the mold 10 above is in the above described configuration placed on a surface with its pins 38 upwardly moved and its lateral walls 22 being sloped, cavities 20 are filled with material to be molded therein. A top press will push onto the material in the cavities 20 via the top open face 14.

A top press P engages the open top face 14 in order to pressurize the material within the cavities 20 as well as to provide an imprint on the block top face 27. As is shown in FIG. 5, the portions 28 of the walls 22 provide for a top section 31 of the block 21 with a generally rectangular configuration.

When the mold 10 is lifted after the material has been provided with enough time for curing in order to provide solidified blocks 21, the pins 38 drop downwardly hence moving the cylindrical push members downwardly as well and allowing the wall portions 30 to move back into the generally straight position as the cylindrical push member is positioned between the recessed ends 60 of the two adjacent levers of the adjacent walls 30.

As shown in FIG. 5, there is a small recess 62 between portion 28 and portion 30 of a wall side 22. This recess allows for easier removal of the mold 10 from the solidified blocks 21 which remain on the surface.

The position of the push member 50 can be adjusted along the pin member 38 so as to provide moving the walls more or less into the cavities, thereby defining greater or lesser slope angles on the block 21. For example, the push member 50 in FIG. 3C is positioned higher along the pin member 38 than the push member 50 in FIG. 3B thereby pivoting the movable wall portion 30 into the cavity 20 at a greater angle. The foregoing can also be provided by adjusting the position of the pin member 38 relative to the main body 11 of the mold. Therefore, when the pin member 38 is positioned outwardly of the main body 11 to a greater degree it will consequently push the wall portions 30 inwardly to a corresponding degree.

Of course, a variety of mold structures including the movable walls of described herein can be provided. In one non-illustrated embodiment a mold with a plurality of cavities including movable walls which are moved by an actuator that so acts to move the wall when the mold is positioned on a surface can be provided. These non-illustrated embodiments include a plurality of cavities in which only some of the walls are movable. As shown herein a cavity is bounded by open top and bottom faces as well as four side walls. It is within the scope of the description to provide any one of those side walls to be movable or any two of the side walls or any three of the side walls or even all four of the side walls.

The various features described above can be combined in a variety of ways to provide other non-illustrated embodiments within the scope of the present description. Although the present description hereinabove has been provided by way of non-restrictive illustrative embodiments thereof, it can be modified, without departing from the scope, spirit and nature of the appended claims.

What is claimed is:

1. A mold for molding material into blocks comprising:
a main body comprising at least one pair of spaced apart lateral walls with at least one pair of spaced apart divider walls extending therebetween so as to define at least one cavity for receiving material therein, at least one of said walls being movable inwardly into said cavity; and
a movable actuator element for acting on said movable wall, said movable actuator element extending outwardly of said main body such that when moved inwardly it so acts on said movable wall as to move it inwardly into said cavity.

2. A mold according to claim 1, wherein said movable actuator element is positioned adjacently said movable wall.

3. A mold according to claim 1, wherein said movable actuator element is outwardly biased.

4. A mold according to claim 4, wherein said movable actuator element is connected to a spring for outwardly biasing said movable actuator.

5. A mold according to claim 1, wherein said main body comprises a top face and a bottom face, said movable actuator element extending outwardly from said bottom face, such that when moved upwardly it causes said movable wall to move inwardly into said cavity.

6. A mold according to claim 1, wherein said movable actuator element comprises a push member that pushes said movable wall inwardly into said cavity as said movable actuator element is moved inwardly.

7. A mold according to claim 6, wherein said position of said push member along the length of said movable actuator element is adjustable so as to vary the degree that said movable wall is pushed into said cavity.

8. A mold according to claim 1, wherein the outward position of said movable actuator element relative to said main body is selectively adjustable so as to provide for moving said movable wall to a corresponding position into said cavity.

9. A mold according to claim 8, wherein said movable actuator element is adjustable between at least first and second positions, said movable actuator element extending outwardly of said main body to a greater degree in the second position than in the first second position, wherein when said movable actuator element is moved inwardly from the second position it moves said movable wall inwardly into said cavity to a greater degree than when moved inwardly from the first position.

10. A mold according to claim 1, wherein said movable wall is pivotally mounted to said main body.

11. A mold according to claim 1, wherein said movable wall comprises a movable portion thereof pivotally mounted to another immovable portion thereof.

12. A mold according to claim 11, wherein said cavity comprises an open top face to receive a press so as to compact the material, said immovable wall portion comprising a recessed end adjacent said cavity top face.

13. A mold according to claim 11, wherein said movable and immovable wall portions are offset relative to one another so as to provide a recess therebetween.

14. A mold according to claim 1, wherein movable wall comprises a rear side comprising a lever that is pushed by said movable actuator element when moved inwardly in said main body.

15. A mold according to claim 1, comprising at least two side by side said cavities separated by a wall section, said wall section comprising said movable wall and an adjacent second movable wall, said movable actuator element being interposed between said two adjacent movable walls, wherein when said movable actuator element is moved inwardly it so acts on said adjacent movable walls as to move each one into a respective said side by side cavity.

16. A mold comprising:
a plurality of spaced apart wall sections;
a plurality of lateral walls extending between each pair of adjacent said wall sections thereby defining adjacent rows of cavities, each said cavity providing for receiving material therein to be compacted, each said wall section comprising adjacent movable walls for being moved into a respective one of two adjacent said cavities; and
a plurality of movable actuation elements, each said element interposed between a pair of adjacent said movable walls and extending outwardly of said main body such that when moved inwardly it so acts on said adjacent movable walls as to move each one inwardly into a respective one of two said adjacent cavities.

17. A mold according to claim 16, wherein said main body comprises a top face and a bottom face, said movable actuator elements extending outwardly from said bottom face, such that when moved upwardly they cause said movable wall to move inwardly into said cavity.

18. A mold according to claim 16, wherein said movable actuator elements comprise respective push members for pushing said movable walls inwardly into said respective cavities as said movable actuator elements are moved inwardly.

19. A mold according to claim 16, wherein said movable walls comprise respective movable portions thereof pivotally mounted to other respective immovable portions thereof.
